(19) United States
(12) Patent Application Publication
(10) Pub. No.: US 2023/0420732 A1
(43) Pub. Date: Dec. 28, 2023

(54) CHLORIDE-BASED SOLID ELECTROLYTE, ALL-SOLID-STATE BATTERY INCLUDING THE SAME, AND METHOD FOR PREPARING THE SAME

(71) Applicant: KOREA ELECTRONICS TECHNOLOGY INSTITUTE, Seongnam-si (KR)

(72) Inventors: Keonho PARK, Seongnam-si (KR); Woosuk CHO, Seongnam-si (KR); Jisang YU, Seongnam-si (KR); Goojin JEONG, Seongnam-si (KR); Kyungsu KIM, Seongnam-si (KR)

(21) Appl. No.: 18/339,119

(22) Filed: Jun. 21, 2023

(30) Foreign Application Priority Data
Jun. 22, 2022 (KR) 10-2022-0076064

(51) Int. Cl. H01M 10/0562

(52) U.S. Cl. CPC H01M 10/0562; H01M 2300/008

(57) ABSTRACT

A chloride-based solid electrolyte with improved lithium ion conductivity and electrochemical oxidation stability is proposed. The chloride-based solid electrolyte may be represented by Chemical Formula, Li₂₊ₐMCl_{6-b}O_{c}, in which some of chloride ions (Cl⁻) are substituted with oxygen ions (O²⁻), wherein M denotes metal which is at least one of Zr, Ti, Hf, Fe, or Co, and wherein −0.5<a+b−2c<0.5 and 0<c<2.

### CROSS REFERENCE TO RELATED APPLICATION

The present application claims priority to Korean Patent Application No. 10-2022-0076064, filed Jun. 22, 2022, the entire contents of which are incorporated herein for all purposes by this reference.

### BACKGROUND

### Technical Field

The present disclosure relates an all-solid-state battery, and more particularly, to a chloride-based solid electrolyte with improved lithium ion conductivity and electrochemical oxidation stability, an all-solid-state battery including the same, and a method for preparing the same.

### Description of Related Technology

In order to meet increasing demands for electric vehicles and large-capacity power storage devices increases, a variety of batteries have been developed.

Lithium secondary batteries have been widely commercialized because they have the best energy density and output characteristics among various secondary batteries. As the lithium secondary battery, a lithium secondary battery (hereinafter referred to as a ‘liquid type secondary battery’) including a liquid-type electrolyte containing an organic solvent is mainly used.

### SUMMARY

One aspect is a chloride-based solid electrolyte with improved lithium ion conductivity and electrochemical oxidation stability, an all-solid-state battery including the same, and a method for preparing the same.

Another aspect is a chloride-based solid electrolyte represented by Chemical Formula below in which some of chloride ions (Cl⁻) are substituted with oxygen ions (O²⁻),
Chemical Formula

Li₂₊ₐMCl_{6-b}O_{c}

wherein M denotes metal which is at least one of Zr, Ti, Hf, Fe and Co, and

wherein −0.5<a+b−2c≤0.5 and 0<c≤2.

In the chloride-based solid electrolyte, M may be Zr, and it may be 0.5≤c≤1.60.

In the chloride-based solid electrolyte, b and c may be equal to each other.

In addition, according to embodiments of the present disclosure, provided is a method for preparing a chloride-based solid electrolyte represented by the above Chemical Formula below by ball-milling LiCl, Li₂O and metal (M) chloride.

In the method, the metal (M) chloride may be ZrCl₄, and it may be 0.5≤c≤1.60.

In the method, preparation of the chloride-based solid electrolyte may be performed in a glove box or dry room that is not exposed to moisture and oxygen or in an inert gas atmosphere.

In addition, according to embodiments of the present disclosure, provided is an all-solid-state battery including a chloride-based solid electrolyte represented by the above Chemical Formula below in which some of chloride ions (Cl⁻) are substituted with oxygen ions (O²⁻).

The all-solid-state battery includes a solid electrolyte membrane, an anode, a cathode, and a separator.

The chloride-based solid electrolyte may be contained in at least one of the solid electrolyte membrane, the anode, the cathode, and the separator.

In addition, the chloride-based solid electrolyte contained in at least one of the solid electrolyte membrane, the anode, the cathode, and the separator may use a plurality of species having different compositions.

The chloride-based solid electrolyte according to the present disclosure provides improved lithium ion conductivity and electrochemical oxidation stability compared to the existing chloride-based solid electrolytes by substituting some of the chloride ions (Cl⁻) with oxygen ions (O²⁻).

The chloride-based solid electrolyte according to the present disclosure provides improved dry room storage stability and high-temperature stability compared to the existing chloride-based solid electrolytes.

The chloride-based solid electrolyte according to the present disclosure can reduce preparation cost thereof compared to the existing chloride-based solid electrolytes because of using metal (M) chlorides based on Zr, Ti, Hf, or Fe, which are relatively abundant in nature.

### BRIEF DESCRIPTION OF THE DRAWINGS

FIG. 1 is a flow chart showing a method for preparing a chloride-based solid electrolyte according to the present disclosure.

FIG. 2 is a graph showing the results of X-ray diffraction analysis of chloride-based solid electrolytes according to embodiments and comparative examples.

FIG. 3 is a graph showing charge and discharge characteristics of all-solid-state batteries using chloride-based solid electrolytes according to embodiments and comparative examples.

### DETAILED DESCRIPTION

The liquid type secondary battery not only causes swelling of the battery due to decomposition of the liquid electrolyte by electrode reaction, but also has a risk of ignition due to leakage of the liquid electrolyte. In order to solve such problems of the liquid type secondary battery, a lithium secondary battery (hereinafter referred to as an ‘all-solid-state battery’) using a solid electrolyte having excellent stability is attracting attention.

The solid electrolytes can be divided into sulfide-based, oxide-based and chloride-based. Since the sulfide-based solid electrolyte has higher lithium ion conductivity than the oxide-based solid electrolyte and is stable in a wide voltage range, the sulfide-based solid electrolyte is mainly used as the solid electrolyte for the all-solid-state battery.

However, the sulfide-based solid electrolyte has a disadvantage in that the chemical stability is relatively lower than that of the oxide-based solid electrolyte, and thus the operation of the all-solid-state battery is not stable. That is, the sulfide-based solid electrolyte easily reacts with moisture in the atmosphere or moisture introduced in the process due to various factors such as residual L₂S or P₂S₇ crosslinking sulfur contained in the structure, and may cause hydrogen sulfide (H₂S) gas to be generated when reacting with moisture. Therefore, the sulfide-based solid electrolyte is handled in an environment such as a glove box with an argon gas atmosphere or a dry room where moisture is removed. In addition, the sulfide-based solid electrolyte has a problem in the preparation process in that the lithium ion conductivity is lowered due to the generation of hydrogen sulfide gas because of its high reactivity with moisture.

The chloride-based solid electrolyte uses chloride ions (Cl⁻), thus providing improved high voltage stability compared to the sulfide-based solid electrolyte. For this reason, studies on the chloride-based solid electrolytes have been actively conducted in these days.

However, the existing chloride-based solid electrolytes have low lithium ion conductivity at room temperature compared to the sulfide-based solid electrolytes. In particular, glass-based chloride-based solid electrolytes have a problem in that lithium ion conductivity decreases because crystallization easily occurs even at a relatively low temperature of 100° C. or less due to the characteristics of the anion employed. In addition, the chloride-based solid electrolyte causes a side reaction with a general anode material at a low temperature, so it suffers from poor thermal and chemical stability.

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

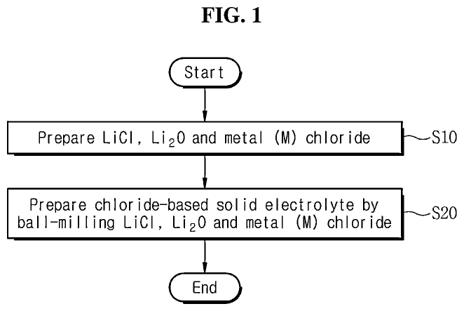

FIG. 1 is a flow chart showing a method for preparing a chloride-based solid electrolyte according to the present disclosure.

Referring to FIG. 1, the method for preparing a chloride-based solid electrolyte according to the present disclosure includes step S10 of preparing LiCl, Li₂O and metal (M) chloride as starting materials, and step S20 of preparing a chloride-based solid electrolyte represented by Chemical Formula below by ball-milling LiCl, Li₂O and metal (M) chloride.

Chemical Formula

Li₂₊ₐMCl_{6-b}O_{c}

wherein M denotes metal which is at least one of Zr, Ti, Hf, Fe and Co, and wherein −0.5<a+b−2c≤0.5 and 0<c≤2.

That is, the chloride-based solid electrolyte according to the present disclosure has a composition in which some of chloride ions (Cl⁻) are substituted with oxygen ions (O²⁻) based on the chloride-based solid electrolyte of Li₂MCl₆. The chloride-based solid electrolyte according to the present disclosure is a glass-based chloride-based solid electrolyte.

The chloride-based solid electrolyte according to the present disclosure can be expressed as LiCl—Li₂O-MCl₄ when the metal (M) chloride is MCl₄.

All steps of the method for preparing the chloride-based solid electrolyte according to the present disclosure are performed in a glove box or dry room or in an inert gas atmosphere so as not to be exposed to oxygen or moisture in the air.

At step S10, a metal (M) chloride based on Zr, Ti, Hf or Fe, which is abundant in nature, is used. For example, the metal (M) chloride may be ZrCl₄.

The starting materials prepared at step S10 may be sufficiently dried at 100° C. in vacuum before being introduced into step S20.

At step S20, LiCl, Li₂O and metal (M) chloride are put into a ball milling container at an appropriate molar ratio to have a composition ratio of the above Chemical Formula, and then synthesized by ball milling to prepare the chloride-based solid electrolyte according to the above Chemical Formula. The ball milling container may be made of zirconia, and zirconia balls may be used.

As such, the chloride-based solid electrolyte prepared by the method according to the present disclosure has a composition in which some of chloride ions (Cl⁻) are substituted with oxygen ions (O²⁻) in the existing chloride-based solid electrolyte represented by Li₂MCl₆. The chloride-based solid electrolyte according to the present disclosure can be represented by the above Chemical Formula.

Since some of chloride ions (Cl⁻) are substituted with oxygen ions (O²⁻), the content (c) of oxygen ions (O²⁻) replacing chloride ions (Cl⁻) may be equal to the loss content (b) of chloride ions (Cl⁻). That is, it may be b=c.

In the process of ball milling, the chloride-based solid electrolyte according to the present disclosure may contain more or less lithium compared to the existing chloride-based solid electrolyte represented by Li₂MCl₆. For example, lithium ions may be added in the same amount as the content (c) of oxygen ions (O²⁻) replacing chloride ions (Cl⁻). That is, it may be a=b=c.

When ZrCl₄ is used as the metal chloride at step S20, the prepared chloride-based solid electrolyte may be expressed as LiCl—Li₂O—ZrCl₄ or Li₂₊ₐZrCl_{6-b}O_{c}. Here, the composition of Li, Cl, and O may be −0.5<a+b−2c≤0.5 and 0.5≤c≤1.60.

The chloride-based solid electrolyte prepared by the preparation method of the present disclosure is a glass or glass-ceramic-based chloride-based solid electrolyte.

The chloride-based solid electrolyte according to the present disclosure is used in an all-solid-state battery. The all-solid-state battery includes a solid electrolyte membrane, an anode, a cathode, and a separator. The chloride-based solid electrolyte is contained in at least one of the solid electrolyte membrane, the anode, the cathode, and the separator. The chloride-based solid electrolyte according to the present disclosure contained in at least one of the solid electrolyte membrane, anode, cathode, and separator may use a plurality of species having different compositions together. For example, the electrode such as the anode or the cathode may contain an active material, a binder, a conductive material, and a solid electrolyte. The solid electrolyte contained in the electrode may include the chloride-based solid electrolyte according to the present disclosure, and the chloride-based solid electrolyte may use a plurality of species having different compositions together.

In the all-solid-state battery according to the present disclosure, the chloride-based solid electrolyte according to the present disclosure is used for at least one of the solid electrolyte membrane, the anode, the cathode, and the separator, and the existing chloride-based solid electrolyte represented by Li₂MCl₆ may be used together with the chloride-based solid electrolyte according to the present disclosure.

The chloride-based solid electrolyte prepared by the preparation method of the present disclosure has a chemical composition in which some of chloride ions (Cl⁻) are substituted with oxygen ions (O²⁻) in the solid electrolyte represented by Li₂MCl₆.

As such, the chloride-based solid electrolyte according to the present disclosure provides improved lithium ion conductivity and electrochemical oxidation stability compared to the existing chloride-based solid electrolytes by substituting some of the chloride ions (Cl⁻) with oxygen ions (O²⁻).

In addition, the chloride-based solid electrolyte according to the present disclosure can reduce preparation cost thereof compared to the existing chloride-based solid electrolytes because of using metal (M) chlorides based on Zr, Ti, Hf, or Fe, which are relatively abundant in nature.

### EMBODIMENTS AND COMPARATIVE EXAMPLES

In order to confirm the lithium ion conductivity of the chloride-based solid electrolyte prepared by the preparation method of the present disclosure, chloride-based solid electrolytes according to embodiments and comparative examples were prepared as follows.

### Comparative Example 1

Starting materials LiCl and ZrCl₄ were put into a zirconia container at a molar ratio of 2:1 together with zirconia balls each having a diameter of 5 mm, and ball milling was performed for 10 hours to prepare a chloride-based solid electrolyte of Comparative Example 1. The chloride-based solid electrolyte of Comparative Example 1 can be represented by chemical formula of Li₂ZrCl₆.

### Comparative Example 2

A chloride-based solid electrolyte of Comparative Example 2 was obtained after storing the chloride-based solid electrolyte of Comparative Example 1 for 24 hours in a dry room where the dew point is maintained at −30° C. or less.

### Comparative Example 3

A chloride-based solid electrolyte of Comparative Example 3 was obtained by vacuum-sealing the solid electrolyte of Comparative Example 1 in a glass ampoule and heat treatment at 100° C. for 12 hours.

### Embodiments 1-24

Starting materials LiCl, Li₂O, and ZrCl₄ were put into a zirconia container at a molar ratio shown in Table 1 together with zirconia balls each having a diameter of 5 mm, and ball milling was performed for 10 hours to prepare chloride-based solid electrolytes according to Embodiments 1-24.

In the chloride-based solid electrolyte according to Embodiments 1-24, the content (c) of oxygen ions (O²⁻) replacing chloride ions (Cl⁻) is 0.05≤c≤2, and a=b=c. That is, a+b−2c=0. The chloride-based solid electrolyte of Embodiments 1-24 can be expressed as Li₂₊ₐZrCl_{6-b}O_{c}.

### Embodiment 25

A chloride-based solid electrolyte according to Embodiment 25 was obtained after storing the chloride-based solid electrolyte according to Embodiment 13 for 24 hours in a dry room where the dew point is maintained at −30° C. or less.

### Embodiment 26

A chloride-based solid electrolyte according to Embodiment 26 was obtained after storing the chloride-based solid electrolyte according to Embodiment 21 for 24 hours in a dry room where the dew point is maintained at −30° C. or less.

### Embodiment 27

A chloride-based solid electrolyte according to Embodiment 27 was obtained by vacuum-sealing the chloride-based solid electrolyte according to Embodiment 13 in a glass ampoule and heat treatment at 100° C. for 12 hours.

### Embodiment 28

A chloride-based solid electrolyte according to Embodiment 28 was obtained by vacuum-sealing the chloride-based solid electrolyte according to Embodiment 21 in a glass ampoule and heat treatment at 100° C. for 12 hours.

TABLE 1

| | | Lithium ion | Activation |
|---|---|---|---|
| | | conductivity | energy |
| | Chemical formula | (S/cm, 25° C.) | (eV) |
| Compar. Example 1 | Li2.000Zr1.000Cl6.000O0.000 | 3.3*10\hat{ }−4 | 0.42 |
| Compar. Example 2 | Li2.000Zr1.000Cl6.000O0.000 | 2.2*10\hat{ }−4 | 0.43 |
| Compar. Example 3 | Li2.000Zr1.000Cl6.000O0.000 | 2.2*10\hat{ }−4 | 0.44 |
| Embodiment 1 | Li2.050Zr1.000Cl5.950O0.050 | 3.3*10\hat{ }−4 | 0.41 |
| Embodiment 2 | Li2.100Zr1.000Cl5.900O0.100 | 3.8*10\hat{ }−4 | 0.41 |
| Embodiment 3 | Li2.150Zr1.000Cl5.850O0.150 | 4.8*10\hat{ }−4 | 0.4 |
| Embodiment 4 | Li2.200Zr1.000Cl5.800O0.200 | 4.5*10\hat{ }−4 | 0.37 |
| Embodiment 5 | Li2.250Zr1.000Cl5.750O0.250 | 5.2*10\hat{ }−4 | 0.38 |
| Embodiment 6 | Li2.300Zr1.000Cl5.700O0.300 | 3.7*10\hat{ }−4 | 0.38 |
| Embodiment 7 | Li2.350Zr1.000Cl5.650O0.350 | 6.2*10\hat{ }−4 | 0.37 |
| Embodiment 8 | Li2.400Zr1.000Cl5.600O0.400 | 8.0*10\hat{ }−4 | 0.35 |
| Embodiment 9 | Li2.500Zr1.000Cl5.500O0.500 | 8.1*10\hat{ }−4 | 0.35 |
| Embodiment 10 | Li2.600Zr1.000Cl5.400O0.600 | 7.5*10\hat{ }−4 | 0.33 |
| Embodiment 11 | Li2.650Zr1.000Cl5.350O0.650 | 9.5*10\hat{ }−4 | 0.34 |
| Embodiment 12 | Li2.666Zr1.000Cl5.334O0.666 | 7.4*10\hat{ }−4 | 0.34 |
| Embodiment 13 | Li2.700Zr1.000Cl5.300O0.700 | 9.9*10\hat{ }−4 | 0.34 |
| Embodiment 14 | Li2.750Zr1.000Cl5.250O0.750 | 7.0*10\hat{ }−4 | 0.34 |
| Embodiment 15 | Li2.800Zr1.000Cl5.200O0.800 | 7.0*10\hat{ }−4 | 0.34 |
| Embodiment 16 | Li2.900Zr1.000Cl5.100O0.900 | 8.7*10\hat{ }−4 | 0.33 |
| Embodiment 17 | Li3.000Zr1.000Cl5.000O1.000 | 1.1*10\hat{ }−3 | 0.34 |
| Embodiment 18 | Li3.050Zr1.000Cl4.950O1.050 | 1.2*10\hat{ }−3 | 0.36 |
| Embodiment 19 | Li3.100Zr1.000Cl4.900O1.100 | 1.3*10\hat{ }−3 | 0.34 |
| Embodiment 20 | Li3.150Zr1.000Cl4.850O1.150 | 1.3*10\hat{ }−3 | 0.34 |
| Embodiment 21 | Li3.200Zr1.000Cl4.800O1.200 | 1.2*10\hat{ }−3 | 0.33 |
| Embodiment 22 | Li3.400Zr1.000Cl4.600O1.400 | 1.0*10\hat{ }−3 | 0.34 |
| Embodiment 23 | Li3.600Zr1.000Cl4.400O1.600 | 7.8*10\hat{ }−4 | 0.34 |
| Embodiment 24 | Li4.000Zr1.000Cl4.000O2.000 | 3.4*10\hat{ }−5 | 0.39 |
| Embodiment 25 | Li2.700Zr1.000Cl5.300O0.700 | 9.0*10\hat{ }−4 | 0.36 |
| Embodiment 26 | Li3.200Zr1.000Cl4.800O1.200 | 1.1*10\hat{ }−3 | 0.34 |
| Embodiment 27 | Li2.700Zr1.000Cl5.300O0.700 | 4.0*10\hat{ }−4 | 0.37 |
| Embodiment 28 | Li3.200Zr1.000Cl4.800O1.200 | 8.3*10\hat{ }−4 | 0.33 |

For the chloride-based solid electrolytes according to Comparative Examples 1-3 and Embodiments 1-28, the lithium ion conductivity was measured through the AC-impedance method, and the measurement results are shown in Table 1.

### Comparison Between Comparative Example 1 and Embodiments 1-24

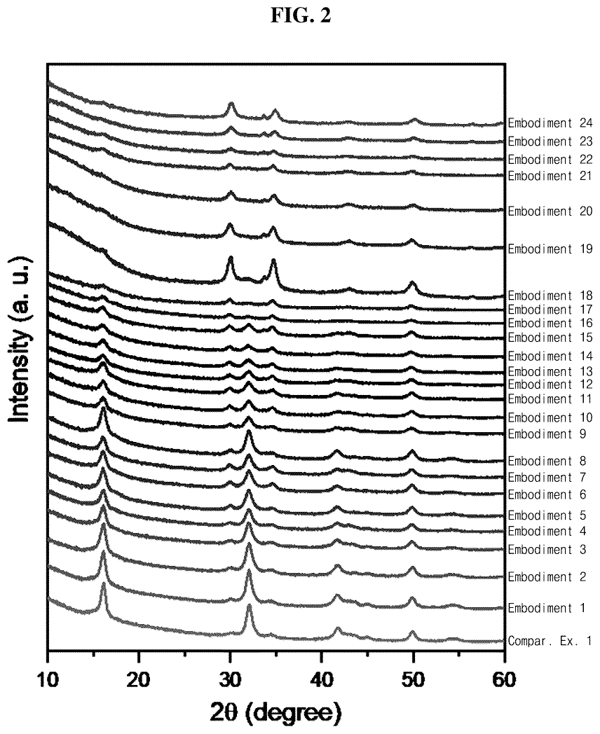

In order to confirm the structures of the chloride-based solid electrolytes according to Comparative Example 1 and Embodiments 1-24, the X-ray diffraction analysis was performed, and the X-ray diffraction analysis results are shown in FIG. 2. Here, FIG. 2 is a graph showing the results of X-ray diffraction analysis of chloride-based solid electrolytes according to embodiments and comparative examples.

Referring to Table 1 and FIG. 2, it can be seen that the chloride-based solid electrolyte according to Comparative Example 1 has a lithium ion conductivity of 3.3×10\hat{ }−4 S/cm at room temperature and has a trigonal crystal structure.

In the case of the chloride-based solid electrolyte according to Embodiments 1-22, it can be seen that as the amount of substitution with oxygen ions (O²⁻) increases, the lithium ion conductivity also increases. In particular, in the case of Embodiment 19, it can be seen that the lithium ion conductivity is greatly increased to 1.3×10\hat{ }−3 S/cm.

On the other hand, in the case of the chloride-based solid electrolytes according to Embodiments 23-24, it can be seen that the increased lithium ion conductivity is decreased again when the substitution amount (c) with oxygen ions (O²⁻) is 1.6 or more.

Compared to Comparative Example 1, in the chloride-based solid electrolytes according to Embodiments 1-24, the intensity of a peak found around 320 is gradually decreased as oxygen ions (O²⁻) are substituted.

Compared to Comparative Example 1, in the chloride-based solid electrolytes according to Embodiments 1-24, the intensity of peaks found at 300 and 34.8° is increased.

In the chloride-based solid electrolyte according to Embodiments 1-24, no impurities corresponding to Li₂O or LiCl were observed. Through this, it can be seen that the chloride-based solid electrolytes according to Embodiments 1-24 have oxygen ions (O²⁻) uniformly substituted inside the crystal and have different structural characteristics compared to Comparative Example 1.

### Comparison of Dry Room Storage Stability

The dry room storage stability was evaluated for the chloride-based solid electrolytes according to Comparative Example 2 and Embodiments 25-26 under the same conditions.

The lithium ion conductivity of the chloride-based solid electrolyte according to Comparative Example 2 was measured as 2.2*10 \hat{ }−4 S/cm.

The lithium ion conductivities of the chloride-based solid electrolytes according to Embodiments 25-26 were measured as 90.0*10\hat{ }−4 S/cm and 1.1*10\hat{ }−3 S/cm, respectively.

As such, it can be seen that the storage stability of the chloride-based solid electrolytes according to Embodiments 25-26 is improved compared to the chloride-based solid electrolyte according to Comparative Example 2 stored under the same conditions.

### Comparison of High-Temperature Stability

The high-temperature stability of the chloride-based solid electrolytes according to Comparative Example 3 and Embodiments 27-28 was evaluated under the same conditions.

The lithium ion conductivity of the chloride-based solid electrolyte according to Comparative Example 3 was measured as 2.2*10\hat{ }−4 S/cm.

The lithium ion conductivities of the chloride-based solid electrolytes according to Embodiments 27-28 were measured as 4.0*10\hat{ }−4 S/cm and 8.3*10\hat{ }−4 S/cm, respectively.

As such, it can be seen that the high-temperature stability of the chloride-based solid electrolyte according to Embodiments 27-28 is improved compared to the chloride-based solid electrolyte according to Comparative Example 3 heat-treated under the same conditions.

### Comparison of Charge/Discharge Characteristics

In order to confirm the charge/discharge characteristics of the chloride-based solid electrolytes according to comparative examples and embodiments, a cell (all-solid-state battery) was manufactured. Here, chloride-based solid electrolytes according to Comparative Example 1, Embodiment 13, and Embodiment 21 were used.

The anode was prepared by uniformly mixing a layered NCM active material, a chloride-based solid electrolyte, and a conductive carbon at a mass ratio of 80:19:1. The separator was prepared by stacking a Li₆PS₅Cl pellet and a chloride-based solid electrolyte pellet. The cathode was prepared by stacking a lithium and an indium foil. The cells according to Comparative Example 1, Embodiment 13, and Embodiment 21 were prepared by sequentially stacking the prepared anode, separator, and cathode.

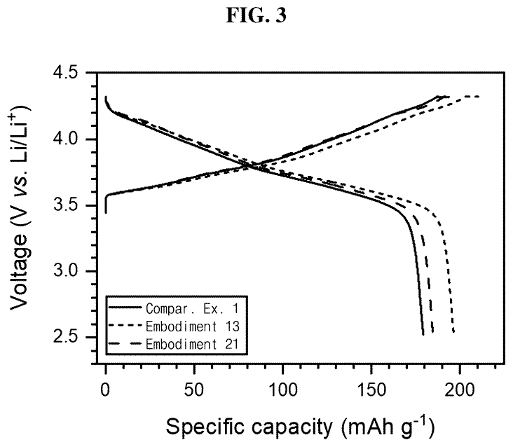

A charge/discharge experiment was performed by applying a current of 0.05 C to the cells according to Comparative Example 1, Embodiment 13, and Embodiment 21, and the experimental results are shown in FIG. 3 and Table 2. Here, FIG. 3 is a graph showing charge and discharge characteristics of all-solid-state batteries using chloride-based solid electrolytes according to embodiments and comparative examples.

TABLE 2

| | Charge | Discharge | Initial |
|---|---|---|---|
| | capacity | capacity | coulombic |
| | (mAh/g) | (mAh/g) | efficiency (%) |
| Compar. Example 1 | 193.71 | 179.31 | 92.56 |
| Embodiment 13 | 210.34 | 196.51 | 93.42 |
| Embodiment 21 | 198.19 | 184.74 | 93.21 |

Referring to FIG. 3 and Table 2, it can be seen that superior capacity expression is possible when the chloride-based solid electrolytes according to Embodiments 13 and 21 are applied to the anode, compared to when the chloride-based solid electrolyte according to Comparative Example 1 is applied to the anode.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. A chloride-based solid electrolyte represented by Chemical Formula below in which some of chloride ions (Cl⁻) are substituted with oxygen ions (O²⁻),
Chemical Formula
Li₂₊ₐMCl_{6-b}O_{c}
wherein M denotes metal which is at least one of Zr, Ti, Hf, Fe, or Co, and wherein −0.5<a+b−2c<0.5 and 0<c≤2.

2. The chloride-based solid electrolyte of claim 1, wherein M is Zr, and 0.5≤c≤1.60.

3. The chloride-based solid electrolyte of claim 1, wherein b and c are equal to each other.

4. A method for preparing a chloride-based solid electrolyte, the method comprising:
providing LiCl, Li₂O and metal (M) chloride; and
ball-milling the LiCl, the Li₂O and the metal (M) chloride to prepare a chloride-based solid electrolyte represented by Chemical Formula below,
Chemical Formula
Li₂₊ₐMCl_{6-b}O_{c}
wherein M is at least one of Zr, Ti, Hf, Fe, or Co, and wherein −0.5<a+b−2c<0.5 and 0≤c≤2.

5. The method of claim 4, wherein the metal (M) chloride is ZrCl₄, and 0.5≤c≤1.60.

6. The method of claim 4, wherein b and c are equal to each other.

7. The method of claim 4, wherein preparation of the chloride-based solid electrolyte is performed in a glove box or dry room that is not exposed to moisture and oxygen or in an inert gas atmosphere.

8. An all-solid-state battery including a chloride-based solid electrolyte represented by Chemical Formula below in which some of chloride ions (Cl⁻) are substituted with oxygen ions (O²⁻),
Chemical Formula
Li₂₊ₐMCl_{6-b}O_{c}
wherein M denotes metal which is at least one of Zr, Ti, Hf, Fe, or Co, and wherein −0.5<a+b−2c≤0.5 and 0<c≤2.

9. The all-solid-state battery of claim 8, wherein the all-solid-state battery includes a solid electrolyte membrane, an anode, a cathode, and a separator, and
wherein the chloride-based solid electrolyte is contained in at least one of the solid electrolyte membrane, the anode, the cathode, or the separator.

10. The all-solid-state battery of claim 9, wherein the chloride-based solid electrolyte uses a plurality of species having different compositions.

11. The all-solid-state battery of claim 8, wherein the chloride-based solid electrolyte is configured to be prepared by synthesizing LiCl, Li₂O and metal (M) chloride through ball milling.

12. The all-solid-state battery of claim 11, wherein the metal (M) chloride is ZrCl₄, and 0.5≤c≤1.60.
